(19) United States
(12) Patent Application Publication
(10) Pub. No.: US 2016/0296881 A1
(43) Pub. Date: Oct. 13, 2016

(54) ABSORPTION OF ATMOSPHERIC CARBON DIOXIDE

(71) Applicant: Ruth MUFFETT, North Sydney, New South Wales (AU)

(72) Inventors: Delwyn Douglas, New South Wales (AU); Ruth Muffett, New South Wales (AU)

(21) Appl. No.: 15/038,634

(22) PCT Filed: Nov. 21, 2014
(86) PCT No.: PCT/AU2014/001067

§ 371 Date: May 23, 2016

(30) Foreign Application Priority Data
Nov. 21, 2013 (AU) 2013904514

(51) Int. Cl. B01D 53/14

(52) U.S. Cl. CPC B01D 53/1475; B01D 53/1493; B01D 2251/604; B01D 2258/06

(57) ABSTRACT

A method, system and apparatus for the at least partial removal of carbon dioxide present in atomospheric air is disclosed. A hydroxide is distributed into atmospheric air. At least some of the carbon dioxide present in atomospheric air and the hydroxide react to form a carbonate compound, thereby at least partially removing carbon dioxide from the atmospheric air.

### TECHNICAL FIELD

A method of converting carbon dioxide is disclosed. A system and apparatus for the conversion of carbon dioxide are also disclosed. The method, system and apparatus may find particular application in the at least partial removal of carbon dioxide present in the atmospheric air of the Earth, although the method, system and apparatus may also be employed in the conversion of carbon dioxide from other locations, such as other atmospheres.

### BACKGROUND ART

Carbon dioxide levels in the atmosphere are considered a significant problem in today's society. The increase in carbon dioxide emissions due to the burning of fossil fuels and deforestation has resulted in increased atmospheric carbon dioxide levels. Carbon dioxide is known to contribute to the trapping and re-radiation of heat. The reduction of carbon dioxide emissions has been a significant focus of research for some time.

Additionally, the capture of carbon dioxide from emission sources, such as at power stations, etc, has been the subject of extensive and continued research. Subsequent to capturing the carbon dioxide, there are different ways in which the carbon dioxide is being stored, such as in underground geological formations.

Slowly, alternative technologies to carbon dioxide storage or reduction, are beginning to emerge. One such technology is described in US2012/0219484, which relates to the use of a multi-stage process to first pass air through a filter to remove some of the carbon dioxide therefrom, and subsequently perform a second stage of carbon capture in a reaction chamber. Another such technology is described in US2011/0318231, which relates to air being collected in an automobile, such as when the automobile is travelling at speed, and directed to a reaction chamber to remove some of the carbon dioxide therefrom. However, such processes are limited in their implementation because of the filters and/or reaction chambers required.

The above references to the background art do not constitute an admission that the art forms a part of the common general knowledge of a person of ordinary skill in the art. The above references are also not intended to limit the application of the method, system and apparatus for the conversion of carbon dioxide as disclosed herein.

### SUMMARY

In a first aspect, a method of at least partially removing carbon dioxide present in atmospheric air is disclosed. In this regard, the disclosed method does not postulate the total removal of carbon dioxide from atmospheric air, but rather discloses the general reduction of carbon dioxide levels present in atmospheric air in an effort to counteract, for example, industrial carbon emissions. In this regard, the method can be considered as the conversion of carbon dioxide (i.e. the chemical conversion or reaction of carbon dioxide) into another, less environmentally damaging, form.

Atmospheric air, in the context of this specification, may include the various layers of gases forming the atmosphere which surrounds the Earth or another planetary body. In this regard, the Earth's atmosphere is commonly defined as including the troposphere (including the planetary boundary layer or peplosphere), stratosphere (including the so-called ozone layer), mesosphere, thermosphere and exosphere layers, although may be further defined by other layers such as the ionosphere or magnetosphere. It should also be appreciated that whilst atmospheric air will primarily be described in relation to the Earth's atmosphere, it can also refer to the atmospheres of other celestial or astronomical bodies, such as planets or stars (including the stellar atmosphere), whether they are currently known or not. Further, whilst this method will primarily be disclosed in relation to the Earth's atmosphere, which contains nitrogen, oxygen, argon, water vapour, carbon dioxide, methane, ozone and other trace gases, other atmospheres may contain different gases, or the same gases in different quantities.

The current method comprises distributing a hydroxide into the atmospheric air. At least some of the carbon dioxide present in the atmospheric air and the hydroxide react to form a carbonate compound, thereby at least partially removing carbon dioxide from the atmospheric air. The resulting carbonate compound may also include bicarbonate compounds (i.e. the carbonate compound may be formed with a carbonate ion (CO₃)²⁻ or a bicarbonate ion (HCO₃)⁻).

This simple, and easily implemented, method has the capacity to reduce the current, undesirably high, global carbon dioxide levels, with the possibility of mitigating or reversing the effects of carbon dioxide emissions. Such a simple method for reducing carbon dioxide levels (i.e. at least partially removing carbon dioxide from the atmosphere) has not been previously contemplated. Research efforts to date have been primarily directed to the capture of carbon dioxide as it is being formed, such as in flue gases from power generation, and storage of the captured carbon dioxide, such as in underground geological formations. Other research efforts have been directed to the capture of carbon dioxide from ambient air, but have required the air to be processed, such as in an air capture collector and subsequently passed through a filter. Such efforts are generally quite energy intensive and may not result in a net reduction in carbon levels. However, the presently disclosed method may be implemented with existing technologies and significant additional energy inputs may not be required.

As will be appreciated, there are many ways in which the hydroxide can be distributed into the atmospheric air, which can be dependent on the hydroxide used, the resulting carbonate compound, the location at which the carbon dioxide is to be removed, etc. In this regard, and in one form, the hydroxide may be distributed into the atmospheric air as an aerosol. The aerosol may be formed with the use of a propellant gas, although no such propellant gas may be required. For example, the hydroxide may be in the form of small solid particles which can simply be released into the atmospheric air, although the solid particles may also be distributed with the assistance of a propellant gas.

In one form, the hydroxide may be present in an aqueous solution. Providing the hydroxide in aqueous form may further simplify its distribution. For example, the hydroxide may be sprayed into the atmospheric air to disperse therein. Providing the hydroxide in an aqueous solution may also simplify formation of an aerosol or fine mist, although it will be appreciated that the form of the hydroxide is not so limited.

In one form, distribution of the hydroxide may comprise releasing the hydroxide into the atmospheric air at a height above ground level. Distributing the hydroxide above ground level can assist in directing the hydroxide to areas in which carbon dioxide is more concentrated. It can also assist in reducing the carbon dioxide levels already in existence, as well as removing carbon dioxide from new emissions (such as at power stations, etc). Further, it can provide sufficient time for the hydroxide to react with carbon dioxide present in atmospheric air.

In one form, the method may further comprise distributing a fluid into the atmospheric air, such that the fluid is at least partially modified. The fluid may be in the form of a gas, liquefied gas or liquid. The fluid may be oxygen, and the oxygen may be at least partially modified to form ozone, such as via the Chapman cycle (whereby an oxygen molecule (O₂) is photolyzed by UV light and splits into two oxygen atoms (O), with each oxygen atom combining with an oxygen molecule to form ozone (O₃)). In embodiments where ozone is formed, the formed ozone may assist in the replenishment of the Earth's ozone layer. For example, the formed ozone may assist in replenishing regions of the ozone layer which have thinned (i.e. the so-called ‘holes’ in the ozone layer).

The hydroxide and fluid need not be distributed at the same time, and each may be distributed at a location which provides the most benefit. For example, the fluid (e.g. oxygen) may be distributed at tropical latitudes, to capitalise on UV light and Brewer-Dobson circulation, and the hydroxide may be distributed over agricultural crops, to capitalise on employing the resulting carbonate compound (e.g. as a fertiliser or biopesticide, depending on the hydroxide distributed).

In one form, the hydroxide and/or fluid may be released via a moving article or object. The moving article or object may be moving vehicles, such as cars, trucks, tractors, aircraft, or water vessels, or may be one or more blades on a windmill or wind turbine, etc. Utilisation of such moving articles or objects may assist with the distribution of the hydroxide, or the resulting by-products, over a larger area. Where the moving articles or objects are moving vehicles (i.e. vehicles that may be contributing to carbon dioxide emissions) the method may also provide a simple way to offset at least a part of their own emissions, as well as providing additional removal of carbon dioxide from the atmosphere. In alternative forms, the hydroxide may be released from a stationary position, such as a building or structure. In this regard, the hydroxide may be stored at an appropriate location on, or in, the building or structure and released therefrom. In such a form, it may be preferable to utilise a propelled aerosol to achieve appropriate dispersion of the hydroxide. Alternatively, the hydroxide may be stored in a separate location from the building or structure and relocated to the building or structure, such as by piping the hydroxide to the building or structure, for distribution therefrom.

In one specific form, the moving article or object may be a moving vehicle such as an aircraft, such as an aeroplane, spacecraft, drone, or similar vehicle. The aircraft may include various types of private, commercial, government, defence, etc aircraft. The use of such aircraft can allow the hydroxide to be distributed over a larger area, thereby increasing the potential for carbon dioxide removal from the atmosphere. Furthermore, the use of such aircraft can provide additional time for the hydroxide to react with the carbon dioxide in atmospheric air, as the hydroxide falls from the height of release to the ground due to gravity. The use of such aircraft can also allow the fluid to be distributed at a preferred location, such as near to a thinned region of the ozone layer.

In one form, the hydroxide may be selected such that the resulting carbonate compound can also be utilised. For example, and in one form, the hydroxide that is distributed may comprise calcium hydroxide. In this regard, the reaction between the calcium hydroxide and atmospheric carbon dioxide forms calcium carbonate and water. The formed calcium carbonate may be used as a fertiliser to improve, for example, agricultural crop quality or to strengthen the shells of marine organisms.

In another example, and in another form, the hydroxide may comprise sodium hydroxide. In this regard, the reaction between sodium hydroxide and atmospheric carbon dioxide forms sodium bicarbonate. The formed sodium bicarbonate may be used, for example, as a biopesticide.

Other hydroxide compounds may also be employed. However, they should be judiciously selected, based both on the properties of the hydroxide compound itself and on the resulting carbonate compound. For example, a hydroxide compound which is hazardous or toxic, or which will result in a hazardous, toxic or otherwise carcinogenic carbonate compound should be avoided.

Additionally, the location at which the hydroxide is distributed into the atmospheric air may also be selected such that the carbonate compound is formed at a location at which the carbonate compound can be utilised. For example, where the carbonate compound can be used as a biopesticide or as a fertiliser, the hydroxide may be released over agricultural farmland, such as by an aeroplane or drone. It may also be possible to employ an aircraft, such as a passenger or cargo plane which is otherwise required to fly over the area to distribute the hydroxide (i.e. so that any additional carbon dioxide emissions are minimised to those relating to the additional weight of the hydroxide being stowed on the plane) rather than employing a separate aeroplane for such a task. Although, it should be appreciated that in some circumstances the employment of a separate aircraft may still be an acceptable solution (i.e. there may still be a net reduction of carbon dioxide from the atmosphere).

In one form, the method may further comprise controlling the amount of hydroxide distributed into the atmospheric air, thereby controlling the amount of carbon dioxide removed therefrom. In this regard, carbon dioxide levels may be monitored to allow the removal of carbon dioxide from the atmospheric air in a controlled manner, as total removal, or removing the carbon dioxide too quickly, is not recommended. Further, the distribution of hydroxide may be limited or ceased if the atmospheric carbon dioxide levels are reduced to a specified level. For example, once the atmospheric carbon dioxide levels are at similar levels to those experienced prior to the Industrial Revolution, the distribution of calcium hydroxide may be limited so that only new carbon dioxide emissions are eliminated.

In a second aspect, a system of at least partially removing carbon dioxide present in atmospheric air is disclosed. The system comprises a mechanism for delivering a hydroxide into the atmospheric air. The carbon dioxide and hydroxide react to form a carbonate compound, thereby at least partially removing carbon dioxide from the atmospheric air. In this regard, the system disclosed in this second aspect may be regarded as a system to enable the method disclosed in the first aspect to be applied. The presently disclosed system, unlike current systems, does not require the use of filters through which air must be filtered. By judiciously selecting the hydroxide, and tailoring the resulting carbonate compound, the presently disclosed system may eliminate the requirement of tanks for capturing or processing the air, or for storage of the by-products. It should be appreciated that the hydroxide may be present in an aqueous solution or as a solid, such as a fine particulate.

In one form, the system may comprise storing a hydroxide compound in a receptacle, located in or on, the mechanism prior to delivery into the atmospheric air. For example, a container, reservoir, vessel, canister or other receptacle may be employed to store the hydroxide. Alternatively, the receptacle may be stored in a location separate to the mechanism and the hydroxide may be relocated to the mechanism from the receptacle, such as by piping the hydroxide to the mechanism, for distribution therefrom.

In one form, the mechanism may deliver the hydroxide into the atmospheric air at a height above ground level. For example, the hydroxide may be distributed in an upper region of the Earth's troposphere, or in the Earth's stratosphere.

In one form, the mechanism may comprise a moving article or object, such as an air-travelling vehicle, a ground-travelling vehicle, a water-travelling vehicle, or other moving object, such as the blades of a turbine. In this regard, the mechanism may be considered as the article or object which transports the hydroxide to the location at which it is to be distributed, and/or from which the hydroxide is distributed. For example, the air-travelling vehicle may be an aeroplane, spacecraft or aerial drone, the ground-travelling vehicle may be a car, truck or tractor, which can be employed to relocate the hydroxide to, for example, an agricultural field. In another example, the water-travelling vehicle may be a boat, ship, yacht, hovercraft, ferry, barge, fishing trawler, canoe, kayak, etc, which can be employed to relocate the hydroxide to, for example, an ocean, lake, river, pond, dam, lagoon or other body of water for distribution into the atmospheric air above said body of water. In yet a further example, the moving article or object may be moving elements on an otherwise stationary structure, such as the blades of a windmill or wind turbine.

In another form, the mechanism may comprise a building or structure. In this regard, the building or structure can be used to mount, for example, the receptacle, from which the hydroxide is then distributed. For example, a receptacle on a tower may be used to pump, spray, or otherwise release the hydroxide into the air.

In one form, the hydroxide may be delivered as an aqueous solution. This may simplify the distribution of the hydroxide, such as by enabling a mist to be formed. However, it should be appreciated that the hydroxide may alternatively be delivered in the form of a solid, such as small/fine solid particles. The hydroxide may also, or alternatively, be delivered as an aerosol (such as fine aqueous particles or fine solid particles).

In forms where the hydroxide is delivered as an aqueous solution, the solution may be formed in the mechanism. For example, the hydroxide may be stored in one compartment of a receptacle, with water being stored in a separate compartment of the same or a different receptacle. The hydroxide and water may only be mixed shortly prior to being distributed into the air. In other forms, the aqueous solution may be formed and then stored in the mechanism, for example in a receptacle, prior to delivery.

In one form, the mechanism may be adapted to deliver the hydroxide into the atmospheric air at a location at which the resulting carbonate compound can be further utilised. For example, the mechanism may be adapted for mounting on or in an aircraft, and may be further adapted to be programmed to deliver or release the hydroxide at a specific location. The specific location may be determinable by a global positioning system (GPS), and the use of known GPS techniques may be employed. Although, it should be appreciated that the mechanism need not be limited to delivering the hydroxide at a location at which the resulting carbonate compound is specifically utilised. For example, the hydroxide may be released over a body of water in which the resulting carbonate compound is not required.

In one form, the mechanism for delivering the hydroxide may allow the amount of hydroxide delivered into the atmospheric air to be controlled. This can thereby control the amount of carbon dioxide removed from the atmospheric air. In this regard, the system may further comprise a carbon dioxide monitor, such as a carbon dioxide sensor. This can allow the carbon dioxide levels to be monitored, which can assist in removing carbon dioxide from the atmospheric air in a controlled manner, as total removal, or removing the carbon dioxide too quickly, is not recommended. Further, the delivery of hydroxide may be limited or ceased if the atmospheric carbon dioxide levels are reduced to a specified level. For example, once the atmospheric carbon dioxide levels are at similar levels to those experienced prior to the Industrial Revolution, the delivery of calcium hydroxide may be limited so that only new carbon dioxide emissions are being eliminated.

In one form, the system may further comprise a mechanism for delivering a fluid into the atmospheric air, such that the fluid is at least partially modified. The fluid may be in the form of a gas, liquefied gas or liquid. The fluid may be oxygen, and the oxygen may be at least partially modified to form ozone. The mechanism for delivering the hydroxide and the mechanism for delivering the fluid may be the same mechanism, such as an aircraft. The hydroxide and fluid may be stored in, for example, separate receptacles, located in or on the mechanism prior to delivery into the atmospheric air. The system may be configured to release/distribute the hydroxide and fluid at different times and/or locations. For example, each may be distributed at a different respective location which provides the most respective benefit.

The system of the second aspect may otherwise facilitate the implementation of the method as defined in the first aspect.

In a third aspect, an apparatus for distributing a hydroxide and at least partially removing carbon dioxide present in atmospheric air is disclosed. The apparatus is configured to distribute the hydroxide into the atmospheric air. The hydroxide reacts with carbon dioxide present in the air, forming a carbonate compound. This allows the at least partial removal of carbon dioxide from the atmospheric air.

Unlike current apparatus, there is no need for filters or capture tanks to retain the resulting products of the reaction between the hydroxide and the atmospheric carbon dioxide.

In one form, the apparatus may be configured to store the hydroxide in a receptacle prior to distribution thereof. This can allow the hydroxide to be easily relocated for distribution in another area or region. The hydroxide may be in the form of a solid, such as a dry powder, which can then be released into the atmospheric air (such as by known crop dusting techniques), or may be a liquid.

In one form, the apparatus may be configured to form an aqueous solution of a hydroxide compound. In this regard, the hydroxide compound may be stored separately in the apparatus, i.e. in its own compartment, and the aqueous solution may be formed when the hydroxide is to be distributed. For example, the hydroxide compound may be stored as a solid in one compartment and water may be stored in a separate compartment, allowing the aqueous solution to be formed when the solution is to be distributed. Although, it should also be appreciated that the aqueous solution may be formed as the hydroxide compound is released into the atmospheric air, taking advantage of the water vapour present therein. Alternatively, the apparatus may be configured to allow the aqueous solution to be formed and stored therein, or the aqueous solution may be formed elsewhere and simply stored therein.

In one form, the apparatus may be configured to aerosolise the hydroxide. In this regard, the aerosol may be formed with a propellant gas, or may simply be sprayed as a fine mist of solid particles or aqueous solution. The use of known aerosolising techniques may be employed.

In one form, the apparatus may be mountable to a fixed or movable object, article or structure, such as a building, vehicle, or crop sprinkler. This can facilitate the distribution of the hydroxide therefrom at the most appropriate location.

The apparatus may further comprise a mechanism to control the amount of hydroxide distributed into the atmospheric air. This can thereby control the amount of carbon dioxide removed from the atmospheric air. In this regard, the apparatus may further comprise a carbon dioxide monitor, such as a carbon dioxide sensor. This can allow the carbon dioxide levels to be monitored, which can assist in removing carbon dioxide from the atmospheric air in a controlled manner, as total removal, or removing the carbon dioxide too quickly, is not recommended. Further, the distribution of hydroxide may be limited or ceased if the atmospheric carbon dioxide levels are reduced to a specified level. For example, once the atmospheric carbon dioxide levels are at similar levels to those experienced prior to the Industrial Revolution, the distribution of calcium hydroxide may be limited so that only new carbon dioxide emissions are eliminated.

In one form, the apparatus may be further configured to distribute a fluid into the atmospheric air, such that the fluid is at least partially modified. The fluid may be in the form of a gas, liquefied gas or liquid. The fluid may be oxygen, and the oxygen may be at least partially modified to form ozone. The apparatus may be configured to store the hydroxide and fluid in, for example, separate receptacles. The apparatus may be configured to release/distribute the hydroxide and fluid at different times and/or locations. For example, each may be distributed at a different respective location which provides the most respective benefit.

The apparatus may otherwise be employed in the method defined in the first aspect, or in the system defined in the second aspect.

### BRIEF DESCRIPTION OF THE DRAWINGS

Notwithstanding any other forms that may fall within the scope of the method, system and apparatus for the conversion of carbon dioxide as set forth in the Summary, specific embodiments will now be described, by way of example only, with reference to the accompanying drawings in which:

FIG. 1 shows a schematic overview of a first embodiment;

FIG. 2 shows a general flow chart of the method; and

FIG. 3 shows a schematic overview of a second embodiment.

### DETAILED DESCRIPTION

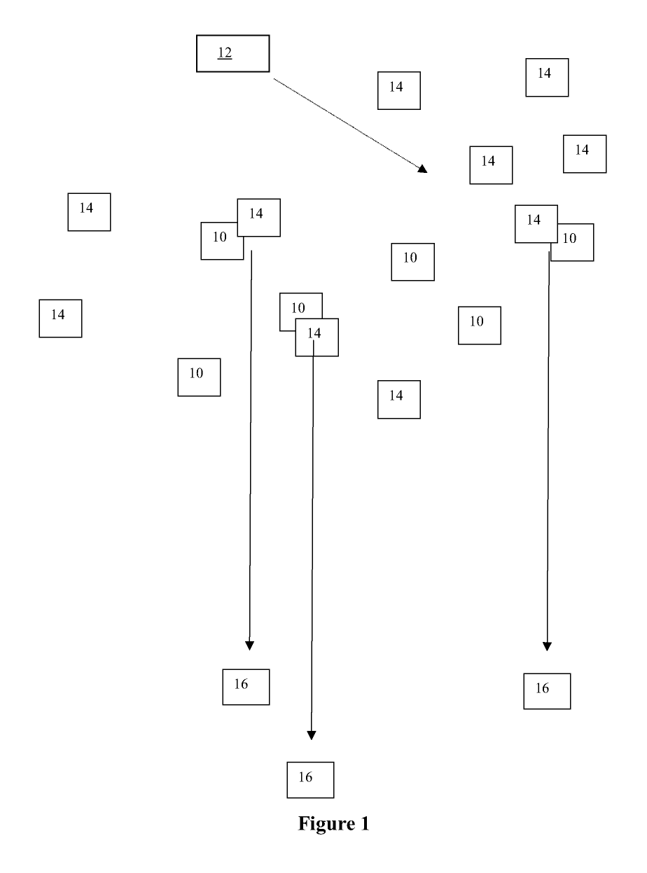

Referring firstly to FIG. 1, a general schematic overview of an embodiment for at least partially removing carbon dioxide from atmospheric air is shown. As previously mentioned, the system can be employed to reduce carbon dioxide levels currently present in atmospheric air in an effort to counteract, for example, industrial carbon emissions. In this regard, the system can be considered as providing for the conversion of carbon dioxide (i.e. the chemical conversion or reaction of carbon dioxide) into another, less environmentally damaging, form. It should also be appreciated that the levels of carbon dioxide can be monitored and the amount of carbon dioxide removed from the atmospheric air can be controlled, such as by controlling the amount of hydroxide being distributed into the atmospheric air. Removing carbon dioxide from the atmosphere too quickly, or removing it altogether, is not recommended. Monitoring of atmospheric carbon dioxide levels can also assist with determining whether distribution of hydroxide should be limited or ceased if atmospheric carbon dioxide levels are reduced to a specified level.

In this embodiment, an aeroplane, shown as 12, distributes a hydroxide, shown as aerosolised calcium hydroxide particles 10, into the air at a height well above the ground. In this regard, the aeroplane 12 may be configured to release the calcium hydroxide particles 10 at a specific height above the ground (although, it is not so limited). By releasing, or distributing, the calcium hydroxide particles 10 at a greater height, the particles 10 have additional time to react with carbon dioxide 14 present in the air. At least some of the carbon dioxide 14 present in the air and the released calcium hydroxide particles 10 react to form a calcium carbonate compound and water, collectively shown as ‘16’. This thereby at least partially removes some of the carbon dioxide, which was present in the air, therefrom. As calcium hydroxide is highly reactive to carbon dioxide, when the calcium hydroxide is released at a considerable height above the ground, it is unlikely that significant quantities of calcium hydroxide will fall to the earth, as it will be converted to calcium carbonate and water.

It can be seen in FIG. 1 that, even though there is some carbon dioxide remaining in the atmosphere, some of the carbon dioxide has been removed from the atmosphere, by converting the carbon dioxide into another form. It can also be seen that some of the calcium hydroxide particles may not react with the carbon dioxide. The unreacted particles may just fall to the earth. This is more likely if the carbon dioxide levels are lower where the hydroxide is distributed. Although, in most circumstances, it is hypothesised that negligible quantities of the hydroxide will reach the earth.

The amount of calcium hydroxide being distributed into the atmosphere can be adjusted according to the levels of carbon dioxide present in the atmosphere. For example, if the carbon dioxide levels in the atmosphere are reduced as a result of the implementation of the method, system and apparatus disclosed herein, such as to pre-Industrial Revolution levels, the amount of calcium hydroxide distributed may need to be reduced (i.e. to prevent too much carbon dioxide being removed from the atmosphere).

The reaction between calcium hydroxide and carbon dioxide is shown by the following equation:

Ca(OH)₂+CO₂→CaCO₃+H₂O

The formed calcium carbonate (CaCO₃) will slowly settle to earth in relatively small concentrations, due to the small droplet size used in aerosolising the aqueous calcium hydroxide.

Even though, in this embodiment, distribution or delivery of the hydroxide has been described as being released by an aeroplane, it will be appreciated that there are many ways in which the hydroxide can be distributed into the atmospheric air, which can be dependent on the hydroxide compound used, the resulting carbonate compound, the location at which the carbon dioxide is to be removed, its form (liquid or solid), etc.

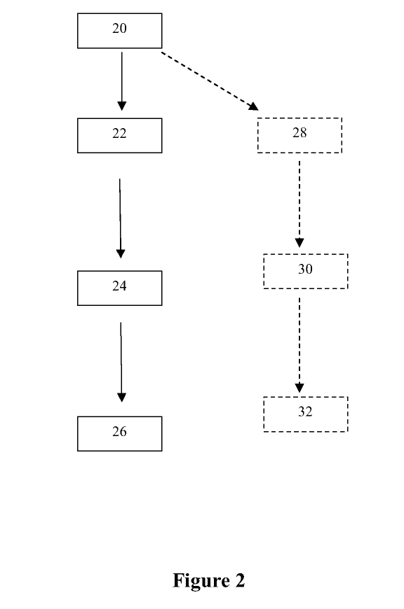

In this regard, a generic flow chart is shown in FIG. 2, outlining the general or generic steps which can lead to the at least partial removal of carbon dioxide from atmospheric air. An apparatus or delivery mechanism, such as an aeroplane, is shown at 20. Distribution of a hydroxide into atmospheric air occurs at 22. The hydroxide reacts with carbon dioxide present in the air at 24, and the resulting carbonate compound, which is formed in the reaction at 24, is shown at 26. This simplified process is what enables the method and system disclosed herein to have such wide and varied applications.

For example, by judiciously selecting the hydroxide compound used the resulting carbonate compound can also be tailored. Those carbonate compounds which can also be used for other purposes, such as calcium carbonate or sodium carbonate, can enable further benefit to be obtained (i.e. the reduction of carbon dioxide levels in the atmosphere may not be the only benefit obtained from employing the disclosed method or system).

Further, the state of the hydroxide compound can be altered, for example it may be distributed as a solid particulate, or it may be an aqueous solution.

FIG. 2 also outlines the general or generic, optional, steps which can lead to the at least partial modification of a fluid, such as oxygen, in atmospheric air. The apparatus or delivery mechanism 20 can be further configured to distribute a fluid into atmospheric air, shown at 28. The fluid is at least partially modified by reacting with a substance (such as a chemical substance or compound) present in the air, or is otherwise modified by components of the environment (such as UV radiation) at 30, and the resulting modified fluid, is shown at 32.

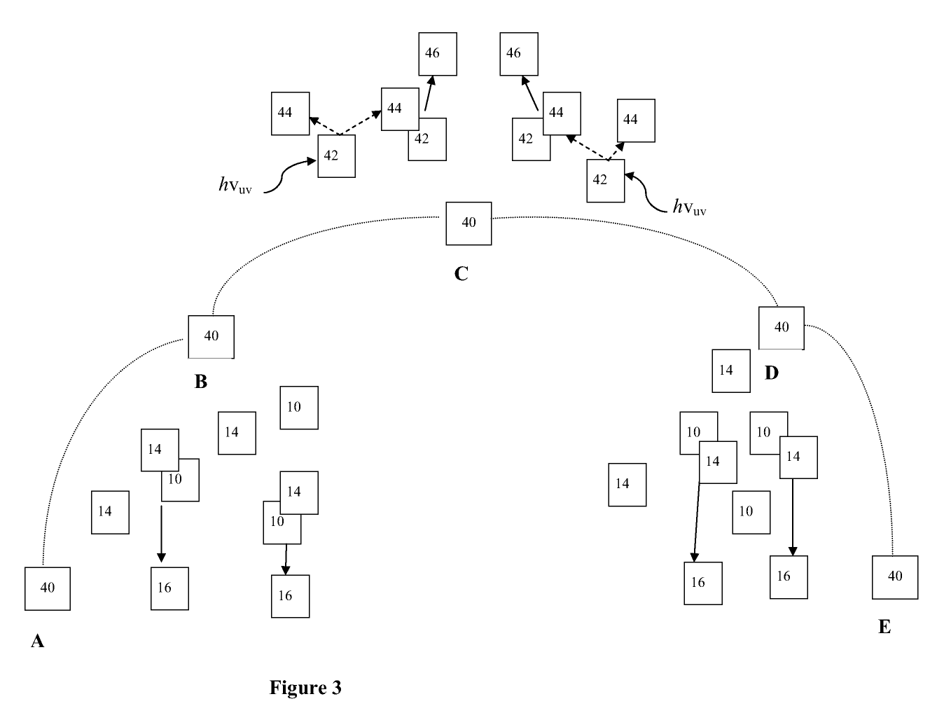

Referring now to FIG. 3, a general schematic overview of a second embodiment for at least partially removing carbon dioxide from atmospheric air is shown. In this second embodiment, an aeroplane 40 is configured to distribute a hydroxide, shown as aerosolised calcium hydroxide particles 10, and a fluid, shown as oxygen molecules 42. FIG. 3 generally depicts the flight path of aeroplane 40, with positions A and E being the aeroplane 40 on the ground, and positions B, C and D being the aeroplane 40 in-flight. As shown in FIG. 3, the calcium hydroxide particles 10 and oxygen molecules 42 are distributed at different locations/position during the flight of aeroplane 40. For example, when the aeroplane 40 is in the vicinity of positions B and D, calcium hydroxide particles 10 are distributed into the air, whereas oxygen molecules 42 are distributed into the air when the aeroplane 40 is in the vicinity of position C. At positions B and D, as before, when the calcium hydroxide particles 10 are distributed into the air at least some of the carbon dioxide 14 present in the air reacts with the calcium hydroxide particles 10 to form a calcium carbonate compound and water, collectively shown as ‘16’. At position C, the oxygen molecules 42 are distributed into the air. In this embodiment, they are shown as being distributed in an upwardly direction (i.e. towards the stratosphere) in an effort to improve the likelihood of ozone formation at the correct location. The oxygen molecules 42 may be photolyzed by UV light (hvᵤᵥ) and split into two oxygen atoms, 44. An oxygen atom 44 may then combine with an oxygen molecule 42 to form ozone (O₃), 46.

In this embodiment, it is possible to both reduce carbon dioxide levels present in atmospheric air (or, at least, partially offset any carbon dioxide emissions generated by the aeroplane) and assist in the replenishment of the Earth's ozone layer.

The disclosed embodiments can allow a variety of methods and systems to be employed. Additionally, little new equipment may be required. For example, a simple tank with a nozzle for creating a fine mist may be mounted into a commercial aeroplane. Once the aeroplane is at an appropriate altitude, or located over an appropriate agricultural field, the hydroxide can be released as a fine mist.

The amount of hydroxide and, optionally, fluid loaded into the container/tank can also be varied depending on the specific requirements of the aircraft. For example, it may be necessary to include additional weight on the aircraft so that it has an even weight distribution. In such cases, additional hydroxide and, optionally, fluid can be loaded onto the flight. Alternatively, where an aircraft is not fully loaded, such as when all seats on the aircraft have not been sold, it may be possible to load hydroxide and, optionally, fluid onto the aircraft for distribution into the atmosphere mid-flight. In a further example, when pilots are training it may be necessary to load additional ‘dead’ weight into the aeroplane. This ‘dead weight’ could be provided by loading hydroxide and, optionally, fluid into the aircraft, which could then be distributed prior to landing. Previously, the additional loading of weight into aircraft was only increasing the carbon dioxide emissions of the aircraft. However, with the presently disclosed method and system, it is possible to utilise this required additional weight to assist with the removal of carbon dioxide from the atmosphere (both their own emitted carbon dioxide, as well as the carbon dioxide emitted by others).

Space craft may also be a viable option for dispersing hydroxide and, optionally, fluid into the atmosphere at a higher altitude than aeroplanes. Again, suitable ratios of hydroxide and, optionally, fluid could allow the additional reduction of carbon dioxide in the atmosphere and, optionally, assist in replenishing of the Earth's ozone layer. Other vehicles, such as cars, trucks, tractors, etc can also be employed to distribute the hydroxide. Utilisation of such vehicles that contribute to carbon dioxide emissions can provide a simple way to offset their own emissions, as well as providing additional removal of carbon dioxide from the atmosphere.

The hydroxide may also be distributed from a boat or other water-travelling vehicle, into the air. An alternative form of moving object, such as the blades or vanes of a wind turbine or windmill, etc, may be used to distribute the hydroxide.

Dispersal of the hydroxide from a stationary position, such as a building or structure, is also a viable embodiment. In this regard, the hydroxide can be stored at an appropriate location on, or in, the building or structure and released therefrom. In such embodiments, it may be preferable to utilise a propelled aerosol to achieve appropriate dispersion of the hydroxide. Alternatively, the hydroxide need not be stored near to the building or structure from which it will be dispersed. For example, the hydroxide may be stored some distance away and transported to the dispersal location, such as by pipes or gravity feeding to the site.

The hydroxide compound will usually be calcium hydroxide, as it results in a carbonate compound (calcium carbonate, as well as water) that poses no significant danger to people and animals, and can be readily utilised for other purposes. The resulting calcium carbonate can be used as a fertiliser to improve, for example, agricultural crop quality or to strengthen the shells of marine organisms. However, sodium hydroxide may also be used as sodium bicarbonate is formed, which can be used as a biopesticide.

Other hydroxide compounds can also be employed. However, the hydroxide compound should be judiciously selected, based both on the properties of the hydroxide compound itself and on the resulting carbonate compound. For example, a hydroxide compound which is hazardous or toxic, or which will result in a hazardous, toxic or otherwise carcinogenic carbonate compound should be avoided.

### EXAMPLE

A non-limiting Example of the carbon dioxide conversion method and system will now be described, with reference to FIG. 2.

17.3 grams of calcium hydroxide, which is soluble in water up to 1.73 g/L, was mixed with water to form 10 Litres of aqueous calcium hydroxide solution. Some of the solution was then put into a spray bottle.

In order to confirm that carbon dioxide present in atmospheric air was reacting with the calcium hydroxide, the solution was sprayed into the air as a fine mist through a nozzle, over a large plastic sheet. The sheet was allowed to dry in the sun to evaporate the water, and a crystalline substance remained on the plastic sheet.

To determine whether the crystalline substance was calcium carbonate, a small amount of the crystalline substance was collected. Hydrochloric acid was added to the crystalline substance, and gas bubbles were observed to rapidly effervesce.

It was understood that the calcium carbonate and hydrochloric acid reacted to give calcium chloride and carbon dioxide, according to the following equation:

CaCO₃+2HCl→CaCl₂+CO₂+H₂O

The potential applications for this simple method and system are significant, and can be used to reduce the carbon dioxide levels in the atmosphere, and theoretically begin to reverse some of the adverse effects of carbon dioxide as a greenhouse gas.

It will be understood to persons skilled in the art that many other modifications may be made without departing from the spirit and scope of the method, system and apparatus as disclosed herein.

In the claims which follow and in the preceding description, except where the context requires otherwise due to express language or necessary implication, the word “comprise” or variations thereof such as “comprises” or “comprising” is used in an inclusive sense, i.e. to specify the presence of the stated features but not to preclude the presence or addition of further features in various embodiments of the method, system and apparatus for the conversion of carbon dioxide.

1-10. (canceled)

11. A method of at least partially removing carbon dioxide present in atmospheric air, the method comprising distributing a hydroxide into air in the atmosphere, such that the carbon dioxide and hydroxide react to form a carbonate compound, thereby at least partially removing carbon dioxide from the atmospheric air.

12. A method as claimed in claim 11 wherein the hydroxide is distributed into the atmospheric air as an aerosol.

13. A method as claimed in claim 11 wherein the hydroxide is present in an aqueous solution.

14. A method as claimed in claim 11 wherein the hydroxide is distributed into the atmospheric air at a location, selected such that the carbonate compound formed can be utilised.

15. A method as claimed in claim 11, wherein distributing the hydroxide comprises releasing the hydroxide into the atmospheric air at a height above ground level.

16. A method as claimed in claim 15 further comprising distributing a fluid into the atmospheric air, such that the fluid is at least partially modified.

17. A method as claimed in claim 16 wherein the fluid is a gas.

18. A method as claimed in claim 16 wherein the fluid is oxygen, and the oxygen is at least partially modified to form ozone.

19. A system of at least partially removing carbon dioxide present in atmospheric air, the system comprising a mechanism for delivering a hydroxide into air in the atmosphere, such that the carbon dioxide and the hydroxide react to form a carbonate compound, thereby at least partially removing carbon dioxide from the atmospheric air.

20. A system as claimed in claim 19 wherein the hydroxide comprises a compound that is stored in a receptacle, located in or on, the mechanism prior to delivery into the atmospheric air.

21. A system as claimed in claim 19 wherein the mechanism delivers the hydroxide into the atmospheric air above ground level.

22. A system as claimed in claim 21 further comprising a mechanism for delivering a fluid into the atmospheric air, such that the fluid is at least partially modified.

23. A system as claimed in claim 22 wherein the fluid is a gas.

24. A system as claimed in claim 22 wherein the fluid is oxygen, and the oxygen is at least partially modified to form ozone.

25. An apparatus for distributing a hydroxide and at least partially removing carbon dioxide present in atmospheric air, the apparatus configured to distribute the hydroxide into air in the atmosphere, such that the carbon dioxide and hydroxide react to form a carbonate compound, thereby at least partially removing carbon dioxide from the atmospheric air.

26. An apparatus as claimed in claim 25 configured to distribute the hydroxide into the atmospheric air at a height above ground level.

27. An apparatus as claimed in claim 26 configured to distribute a fluid into the atmospheric air, such that the fluid is at least partially modified.
